(19) United States
(12) Patent Application Publication
(10) Pub. No.: US 2002/0042800 A1
(43) Pub. Date: Apr. 11, 2002

(54) Method for note recording the contents of the web page on line

(76) Inventor: Weng Jen Hwang, Jungli City (TW)

Correspondence Address: DOUGHERTY & TROXELL, SUITE 1404, 5205 LEESBURG PIKE, FALLS CHURCH, VA, 22041, US

(21) Appl. No.: 09/887,430

(22) Filed: Jun. 25, 2001

(30) Foreign Application Priority Data
Oct. 7, 2000 (TW) 89113704

(51) Int. Cl. G06F 15/00

(52) U.S. Cl. 707/512

(57) ABSTRACT

The present invention relates to providing a technology for readers to rapidly note record the needed information on the Internet for use. The readers can make use of the Note Record Object, the asynchronous Operation Object, and the File Operation Object to enable them to note record the needed information on line more easily. The File Operation Object can produce/delete a folder and a file. The Asynchronous Operation Object can transmit asynchronously various kinds of files between the reader and the server. The Note Record Object can write/insert the letters, the pictures and the medium objects into various kinds of files.

### FIELD OF THE INVENTION

The present invention relates to providing a technology for note recording the contents of the web page on line.

### DESCRIPTION OF THE PRIOR ART

At present, the Internet is growing in speed, the related industries are also emerging with the tide of the times and growing fast and strong. The unlimited spread characteristic, the capacity of containing various kinds of information and the cheap communication cost of the Internet are the reasons for freedom and speed of information communication. Nowadays, there are more than 10 million websites that provide all kinds of information. For modern people, it becomes no problem to access information but the right click of the right information chosen among tons of information.

For the purpose of information selection, some of the websites provide the mechanism of interaction with the readers to select information. Even so, from another aspect, most of the websites providing interaction function are still one way of demonstration because the function of interaction is only the information selection. However, the usage of information should be of two ways, and it should not be just for browsers; in the interaction websites, the information can be selected as wanted and browsed, but not all website masters would like the readers to note record the demonstration content freely. Although some of the websites will sell their information by membership and allow their members access the selected information by providing tools for selecting information, however, the method for the members to access information is mostly by downloading the full text, but not freely and rapidly note record any wanted part of the full text while browsing the website, which may not be the perfect solution. In fact, the goal to spread information by Internet is not only to demonstrate information passively, but also to use the information dynamically. However, as to better usage of the information, the information providers should not only legitimize the readers to note record the information but also provide them the easy tools for it. In this way, the readers can note record the needed information rapidly on the Internet and use it for special purposes.

It will emphasize the advantages to legally and rapidly note record the content of the website if the readers can note record the needed information rapidly on the Internet for use, such as the application of on line teaching. In other words, the content of teaching materials (comprising the following digital data: letter, picture, voice or image data) can be transmitted on the Internet and demonstrated by website page, and its content can allow the teachers to choose immediately and note record rapidly the teaching notes during the teaching process, also for students' review after classes. In this way, it will save students the time to take notes and speed the teaching program that students will focus on studying without interruption; also, teachers do not have to draw the black table and the teaching tempo would not be interrupted due to time waiting for students to take notes. As a result, it will improve teaching quality. Besides, some of the contents (comprising the following data: pictures, voices or other medium information) not suitable for taking notes during class can also be integrated while teaching for students' review after classes. It also applies to the edit of teaching plan. If teachers can note record the teaching materials (comprising the following data: letters, pictures, voices or other medium materials) in professional edits legally on the Internet to fulfill the contents of teaching plan, it will not only enlarge the scope and enrich the styles of teaching materials, but also promote the quality of teaching materials due to its professional editing of the teaching. It will result in a teaching plan born rapidly. In this case, it will save the time of making teaching plans for teachers on one side, on the other side, teachers can focus on the contents of teaching plans but not put too much efforts on the details of teaching plan making, which will be very helpful in promoting the quality of teaching plans.

However, the tools for the readers to rapidly note record the needed information on the Internet for use are yet to be developed. As above described, if the readers are intended to access information on the Internet, they have to download the full text and edit it, or by the scrapbook function in the operating system to copy the needed information first, then write into a specific file. This method to access information will not apply to the need for immediate note recording of above mentioned on line teaching, and also not be convenient for the making of teaching plans. Based on this reason and the spirit of invention, the inventor thinks of a method and its structure to solve the above mentioned problem, and after some deep survey and experiment, this excellent invention is finally born.

### SUMMARY OF THE INVENTION

The main objective of this invention is to provide a method for readers to rapidly note record the needed information on the Internet for use.

The feature of the present invention is to provide a server for users to note record the contents of the web page on line, wherein the server further comprises:

(1) File Operation Object: It can produce/delete the folder and the file;

(2) Asynchronous Operation Object: It can transmit asynchronously various kinds of files between the reader and the server; and

(3) Note Record Object: It can write the letter or insert the medium object into various kinds of files.

The reader can download the above objects. The File Operation Object will establish the correlated folder on the reader side automatically. Then, the Note Record Object will establish a note record file inside the correlated folder and to write the web page's contents selected by the reader into the note record file automatically. The contents of the web page comprises the letters, the pictures, the voices and the medium objects, wherein the contents of the web page can be transmitted to the correlated folder on the reader side by the Asynchronous Operation Object for asynchronous operation.

### BRIEF DESCRIPTION OF THE DRAWINGS

FIG. 1 is the structure of using environment for this invention;

FIG. 2 is the hardware structure of this invention;

FIG. 3 is the flow chart of this invention, which specifies the process after the reader registers in the server, and before the reader note recording the contents of the web page;

FIG. 4 is this invention's process flow of the letters note recorded from the web page;

FIG. 5 is this invention's process flow of the pictures note recorded from the web page;

FIG. 6 is this invention's process flow of the voice note recorded from the web page;

FIG. 7 is this invention's process flow of the medium object note recorded from the web page;

FIG. 8 is this invention's process flow of the appendix note recorded from the web page on the server side; and

FIG. 9 is the technology of this invention for using the hardware structure in the computer equipments for providing the note recording digital information.

### DESCRIPTION OF THE PREFERRED EMBODIMENT

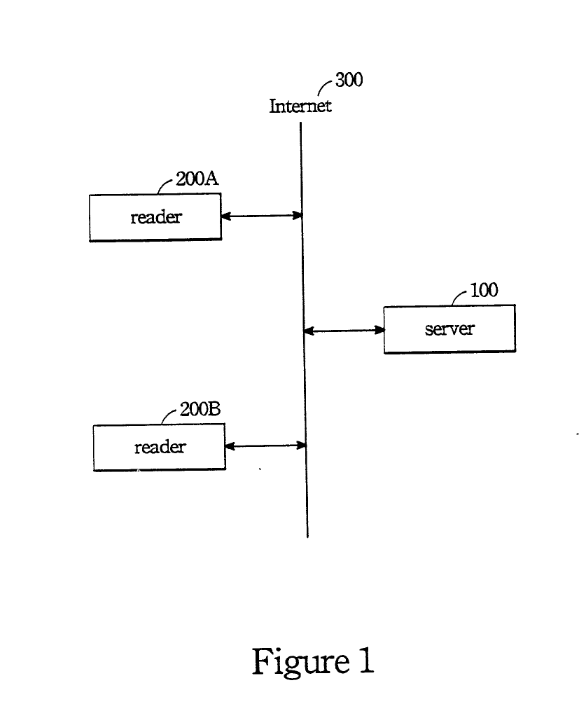

Please refer to FIG. 1 which shows the structure of using environment for this invention, many readers 200 register in the server 100 via the connection of the Internet 300.

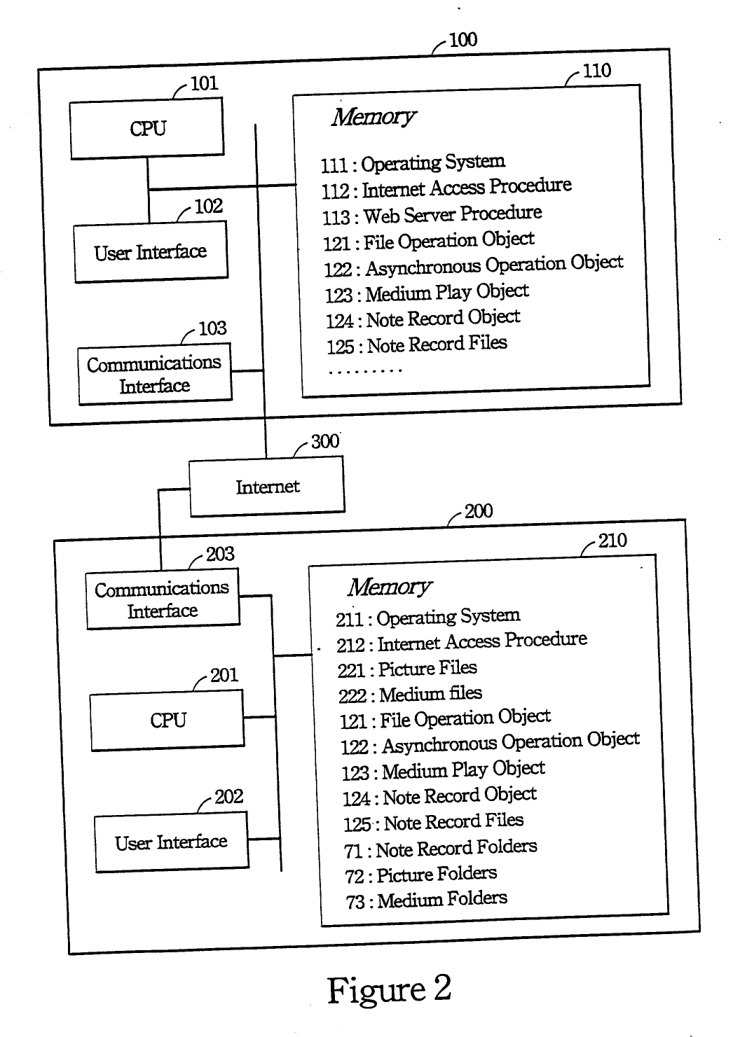

Please refer to FIG. 2 which shows the hardware structure of this invention, which:

Server 100:

101: CPU

102: User Interface

103: Communications Interface

110: Memory

111: Operating System

112: Internet Access Procedure

113: Web Server Procedure

121: File Operation Object

The File Operation Object 121 can produce/delete the folder and the file. This object can be an ActiveX object made by the Visual Basic language of Microsoft and the FileSystemObject of Microsoft scripting runtime, for example. The reader 200 can download this object via the connection of the Internet 300.

122: Asynchronous Operation Object

The Asynchronous Operation Object 122 can transmit asynchronously various kinds of files between the reader 200 and the server 100. This object can be an ActiveX object made by the UserControl object of the Visual Basic language of Microsoft, for example. The reader 200 can download this object via the connection of the Internet 300.

123: Medium Play Object

The Medium Play Object 123 can accept an actual path of a medium object (includes voice, video object, and so on) and play the content of the medium object. This object can be an ActiveX object made by the Visual Basic language of Microsoft and the medium function database “winmm.dll” of Lib and the instruction of MCI (Media Control Interface) of API (Application Programming Interface), for example. If the special medium object is played, it will require the corresponding MCI driver program. The reader 200 can download this object via the connection of the Internet 300.

124: Note Record Object

The Note Record Object 124 can write the letter or insert the medium object into various kinds of files. This object can be made by the Visual Basic language and the Visual Basic for Applications of Microsoft, for example. To illustrate, the ActiveX which is made by the Visual Basic language of Microsoft and Microsoft Word 9.0 Object Library can write or insert the selected letter, picture, voice or other medium object into the Word file and save it. The reader 200 can download this object via the connection of the Internet 300.

125: Note Record Files

The readers choose contents on the web page or any appendix on the reader side, and pass back the contents or the appendix selected to the server side, the server will then note record the contents passed back or note record related contents according to the appendix and save them in the note record file inside the server. In this way, after the users note record the contents on the web page on the reader side, the users can use the Single-Action to request for note recording. The Single-Action will enable the Note Record Object 124 to establish (or open) a note record file on the reader side and write or insert the selected contents of the web page into the note record file.

Reader 200:

201: CPU

202: User Interface

203: Communications Interface

210: Memory

211: Operating System

212: Internet Access Procedure

221: Picture Files

The Picture Files 221 can transmit asynchronously the data from the server 100 to the reader 200.

222: Medium Files

The Medium Files 222 can transmit asynchronously the data from the server 100 to the reader 200.

121: File Operation Object

The File Operation Object 121 can be downloaded from the server 100.

122: Asynchronous Operation Object

The Asynchronous Operation Object 122 can be downloaded from the server 100.

123: Medium Play Object

The Medium Play Object 123 can be downloaded from the server 100.

124: Note Record Object

The Note Record Object 124 can be downloaded from the server 100.

125: Note Record Files

The Note Record Files 125 are saved on the reader side when readers note record the contents on the web page.

71: Note Record Folder

The Note Record Folder 71 is established on the reader side by the File Operation Object 121 and used to put the Note Record Files 125 of the reader side.

72: Picture Folder: The Picture Folder 72 is established on the reader side by the File Operation Object 121 and used to put the Picture Files 221 of the reader side.

73: Medium Folder

The Medium Folder 73 is established on the reader side by the File Operation Object 121 and used to put the Medium Files 222 of the reader side.

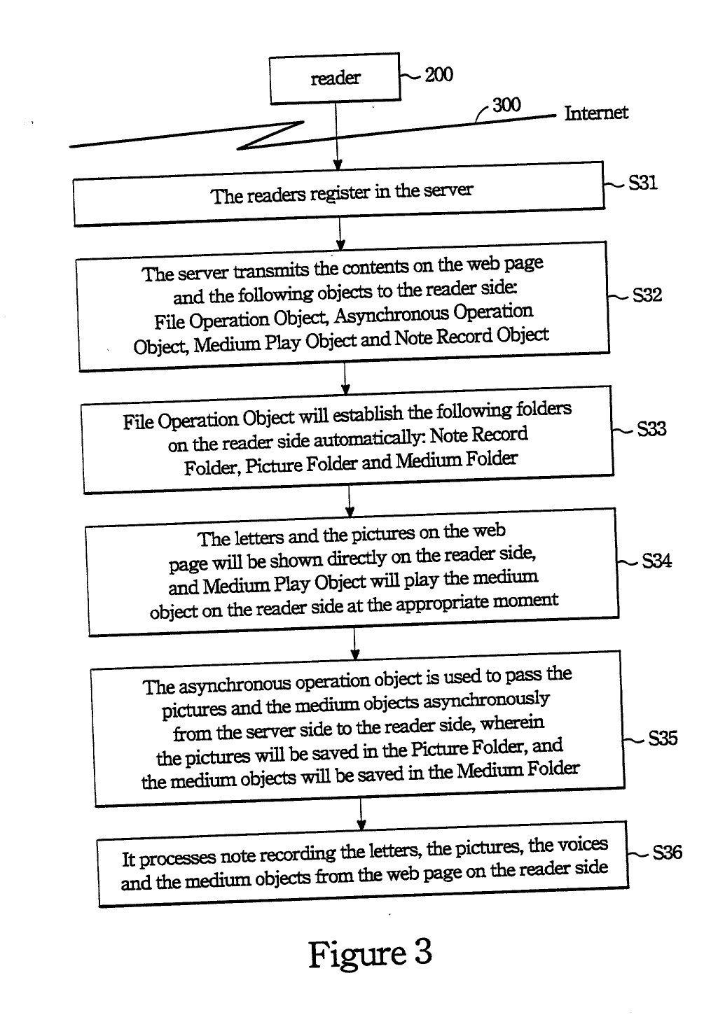

FIG. 3 is the flow chart of this invention, which specifies the process after the reader 200 registers in the server 100, and before the reader note recording the contents on the web page. Please refer to FIG. 3, which:

Step S31: The reader 200 registers in the server 100 via the connection of the Internet 300.

Step S32: The server 100 transmits the contents on the web page and the following objects to the reader side 200: the File Operation Object 121, the Asynchronous Operation Object 122, the Medium Play Object 123 and the Note Record Object 124.

Step S33: The File Operation Object 121 will establish the following folders on the reader side 200 automatically: the Note Record Folder 71, the Picture Folder 72 and the Medium Folder 73.

Step S34: The letters and the pictures on the web page will be shown directly on the reader side 200, and the Medium Play Object 123 will play the medium object on the reader side 200 at the appropriate time.

Step S35: While the web page contents finish transmitting, the asynchronous operation object 122 is used to pass the pictures and the medium object asynchronously from the server side 100 to the reader side 200. The picture file is the Picture Files 221 on the web page and will be saved in the Picture Folder 72. The voice and other medium objects is the Medium Files 222 on the web page and will be saved in the Medium Folder 73.

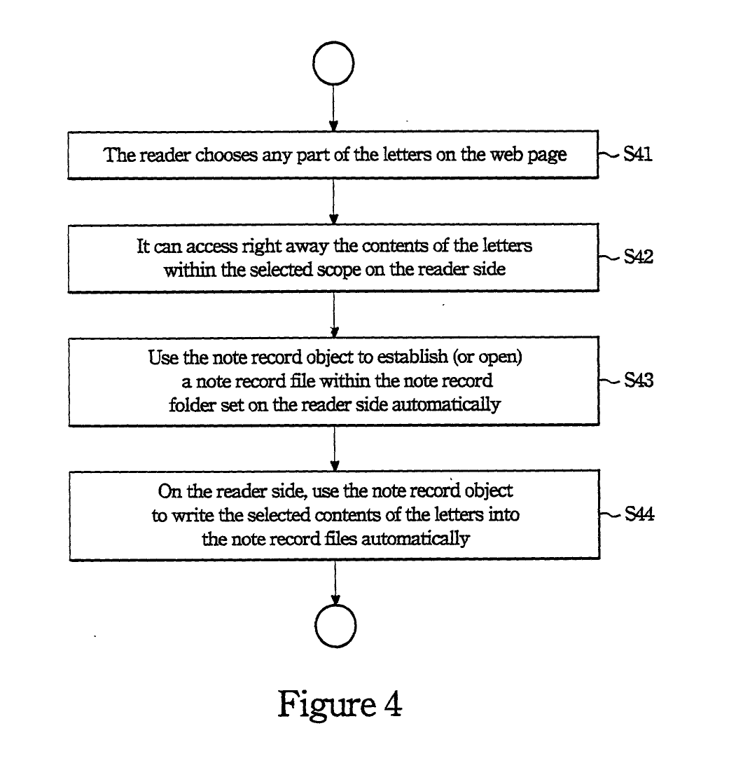

Step S36: It processes note recording the contents of the web page on the reader side, please see FIGS. 4-7 referring the process flow of note recording the letters, the pictures, the voices and the medium objects from the web page on the reader side.

FIG. 4 is this invention's process flow of the letters note recorded from the web page. Please refer to FIG. 4, which:

Step S41: The reader 200 chooses any part of the letters on the web page.

Step S42: It can access right away the contents of the letters (NoteText) within the selected scope on the reader side by the HTML object model.

Step S43: Use the note record object 124 to establish (or open) a note record file automatically (i.e. the Note Record Files 125) within the note record folder 71 on the reader side. For example, a Word file (to open the old file if the readers note record the contents of the web page for the 2^{nd} time), its file name can be preset as the readers' accounts. The note record file can also be any one file existed on the reader side, and the reader can open this existed file during note recording. In this way, the readers can use the Single-Action to request for note recording. The Single-Action will enable the note record object 124 to establish (or open) a note record file on the reader side and write or insert the selected web page contents into that note record file.

Step S44: On the reader side, use the note record object 124 to write the selected NoteText into the note record files 125 automatically.

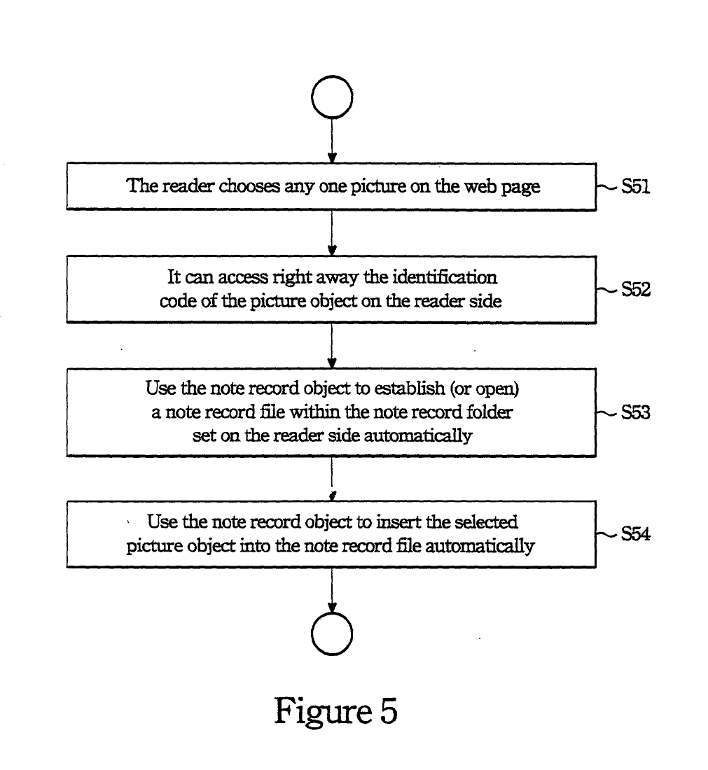

FIG. 5 is this invention's process flow of the pictures note recorded from the web page. Please refer to FIG. 5, which:

Step S51: The reader 200 chooses any one picture on the web page.

Step S52: It can access right away the identification code (NotePic) of the picture object on the reader side by the HTML object model.

Step S53: as the step S43.

Step S54: According to the identification code (NotePic) of the selected picture, getting automatically the picture file from the established Picture Folder 72. And use the note record object 124 to insert the picture file into the note record files 125 on the reader side.

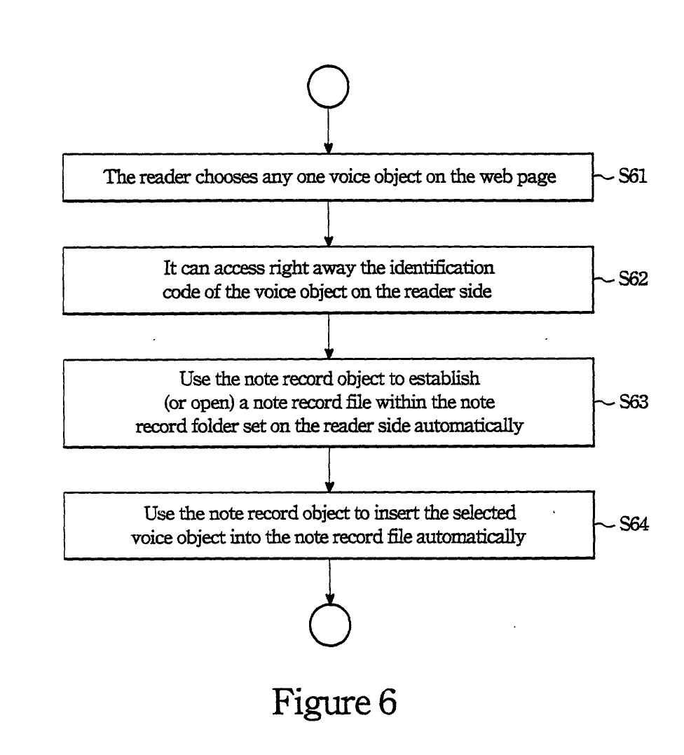

FIG. 6 is this invention's process flow of the voice object note recorded from the web page. Please refer to FIG. 6, which:

Step S61: The reader 200 chooses any one voice object on the web page.

Step S62: It can access right away the identification code (NoteSou) of the voice object on the reader side by the HTML object model.

Step S63: as the step S43.

Step S64: According to the identification code (NoteSou) of the selected voice object, getting automatically the voice file from the established Medium Folder 73. And use the note record object 124 to insert the voice file into the note record files 125 on the reader side.

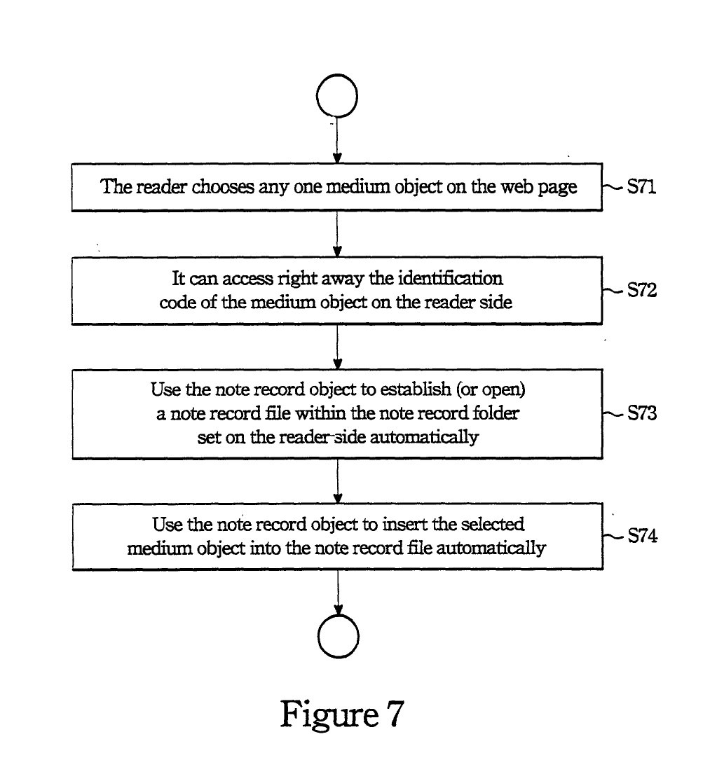

FIG. 7 is this invention's process flow of the medium object note recorded from the web page. Please refer to FIG. 7, which:

Step S71: The reader 200 chooses any one medium object on the web page.

Step S72: It can access right away the identification code (NoteMed) of the medium object on the reader side by the HTML object model.

Step S73: as the step S43.

Step S74: According to the identification code (NoteMed) of the selected medium object, getting automatically the medium file from the established Medium Folder 73. And use the note record object 124 to insert the medium file into the note record files 125 on the reader side.

Besides, the technique of this invention can note record the contents of the web page not only the letters, the pictures, the voices and the medium objects mentioned above, but also other web pages' objects. To take hyperlink object as an example, if the reader chooses any one of the hyperlink objects on the web page, we can then use the HTML object model right away to access the link strings and its URL (Uniform Resource Locator) of the hyperlink object on the reader side. Also, we can use the note record object 124 to plug the hyperlink object into the note record files 125 on the reader side automatically.

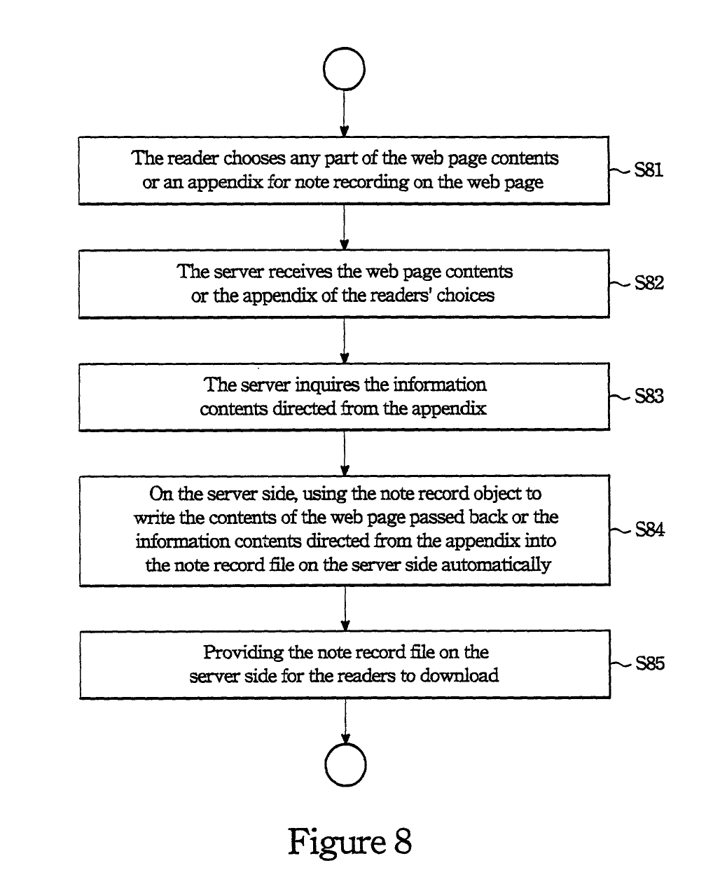

Another way is as the following. The web page contents transmitted from the server side 100 to the reader side 200 include the appendix of the related information. If the readers note record the web page contents or the related information from an appendix, they can choose the web page contents or the appendix and note record that on the server side, please refer to FIG. 8 for its steps:

stepS81: The reader 200 chooses any part of the web page contents or an appendix for note recording on the web page.

stepS82: The server side 100 receives the web page contents or the appendix of the readers' choices. The reader can pass back the selected web page contents or the appendix to the server side by ways of the Form or QueryString while the web page is closed, or using for example RDS (Remote Data Service Object) built inside Microsoft's IE (Internet Explorer), to pass back the selected web page contents or the appendix to the server side at the same time of choosing and note recording.

Step S83: The server then inquires the information contents directed from the appendix. The action of inquiring can be also on the reader side by using RDS (Remote Data Service Object) at the same time of choosing and note recording, to activate the inquiring mechanism on the server side and enforce the inquiring.

Step S84: On the server side, using the note record object 124 to write the contents of the web page passed back or the information contents directed from the appendix into the note record files 125 on the server side automatically. Also, the action of note recording can be on the reader side, using RDS (Remote Data Service Object) to activate the note record object 124 on the server side at the same time of choosing and note recording, and write the contents of the web page passed back or the information contents directed from the appendix into the note record files 125 on the server side.

Step S85: Providing the note record files 125 on the server side for the readers to download.

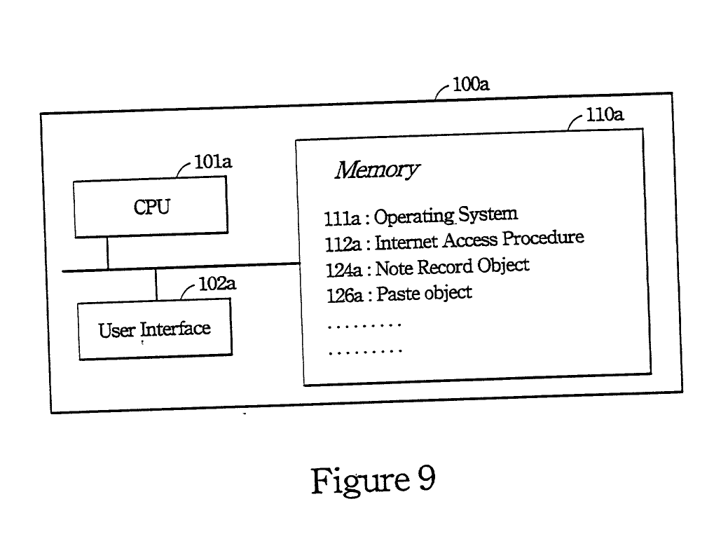

Please refer to FIG. 9, the technique mentioned above can also be used in the computer equipments 100a (e.g. electronic dictionary or PDA (Personal Digital Assistant)) for providing the note recording digital information. To take electronic dictionary as example, though current electronic dictionary can save demonstrated information (only for full text saving but not saved as files), it can not note record any part of it and save as files for the readers to use, which means the readers can not edit the saved information (unless connect the computer to export the information and save as files for editing). Besides, although some of the database software can export the information to files, it can not choose any part of the information demonstrated to export to files, it can only export the whole demonstrated information to files.

The computer equipments 100a for providing the note recording digital information (e.g. the server 100) comprises the CPU 101a, the user interface 102a and the memory 110a, wherein the memory 110a comprises the operating system 111a and the data access procedure 112a (instead of the Internet access procedure 112). The feature of the computer equipments 100a is that the memory 110a further comprises the necessary note record object 124a. Besides, the memory 110a can include the paste object 126a. The paste object 126a can be an ActiveX object made by the Visual Basic language and the Clipboard object of Microsoft for example, it can copy the selected contents to the scrapbook in the operating system. If the computer equipment 100a for note recording digital information uses the normal application program to demonstrate the page, the users can use the paste object 126a to access both the selected letter contents or the medium object for use of note recording. But if the computer equipment 100a for note recording the digital information uses the browser program to demonstrate the page, the users do not have to use the paste object 126a but use the HTML object model directly to access both the selected letter contents or the medium object for use of note recording.

The products of CAI (computer-assisted instruction) sold in the market can be used for the same technique. If the contents inside the CAI include the basic teaching materials and also the program codes of the note record object and the paste object of this invention, then the users can also choose any part of contents for note recording within the teaching materials demonstrated, and write the contents selected into various kinds of files.

Besides, the technique of this invention can also apply to the normal browser software. On the normal browser software, if the program code for the note record object is added into the existing browser software, then the users can use it to note record the web page contents to various kinds of files easily. The users can choose and obtain any part of the web page letters by the HTML object model, and access the pictures or the medium object chosen within the temporary folders in the browser (take Internet Explorer as an example, the temporary folders is the “Temporary Internet Files”). In this way, the note record object can establish a note record file on the user side and write the chosen web page contents into the note record file easily. The present methods for the browser to access the web page contents are mostly by “saving as”. However, the method of “saving as” can not choose any individual part of the web page contents, but only access the full text of the web page. If it is to note record partial web page contents, the processes will be too complicated. Take note recording partial web page contents to the Word files as example, the users choose partial web page contents firstly, and access the contents selected by the scrapbook in the operating system. Then open a new Word file, retrieve the selected web page contents from the scrapbook and paste it, and save it finally and close the Word file. If the technique of this invention is used, it will need only two processes: the action of choosing, and the action of note recording, then the goal for note recording can be achieved.

The technique of this invention can also apply to the normal Office software, such as the software of official document process (e.g. Word of Microsoft), trial balance (e.g. Excel of Microsoft), database (e.g. Access of Microsoft), e-mail (e.g. Outlook of Microsoft) and presentation (e.g. PowerPoint of Microsoft) etc., or apply to normal reading software for e-books (e.g. Adobe Acrobat Reader). If the program code for the note record object is added into the above-mentioned software, then the users can use it to note record the digital information demonstrated to various kinds of files easily. The digital information selected by the users can be accessed by the function of scrapbook in the operating System, or by using Microsoft's Visual Basic for Applications language to write a program code which can add the function of scrapbook to the note record object in order to directly access the selected digital information. Then the note record object can establish a note record file on the user side, and write the accessed digital information into the note record file easily. Currently, the reading software of e-book has no function for note recording, and the note recording for Office software is as stated before that its processes is too complicated, so if the technique of this invention can be used, then the goal for note recording can be achieved with fewest steps.

In conclusion, this invention is a great adventure for note recording contents. One thing to be reminded is that the note record files do not have to be inside the note record folder 71, they can be also put directly under the root catalogue of any hardware on the reader side. Besides, the picture files, the voice files and the medium files for note recording can also be retrieved from the temporary folder of browser (take Internet Explorer as example, the temporary folder is the “Temporary Internet Files”) in order to note record. Those files do not have to be retrieved from the picture folder 72 or the medium folder 73. Since the pictures, the voices or other medium files to be note recorded can also be retrieved from the temporary folder of browser, they do not have to be transmitted to the reader side by asynchronous operation, so the asynchronous operation object is not absolutely necessary; moreover, the note record file doesn't have to put under a specific folder, so the file operation object is not absolutely necessary. The file operation object and the asynchronous operation object used are simply for the easy management of files.

As is understood by a person skilled in the art, the foregoing embodiments of the present invention are illustrated of the present invention rather than limiting of the present invention. It is intended to cover various modifications and similar arrangements included within the spirit and scope of the appended claims, and the scope of which should be accorded the broadest interpretation in order to encompass all such modifications and similar structures.

What is claimed is:

1. A method for note recording the contents of a web page on line, said method comprising the steps of:
displaying said web page in a browser of a reader side, wherein said web page is transmitted from a server via the connection of the communication link;
transmitting a note record object to said reader side if said reader wants to note record said contents of said web page, wherein said note record object can write a letter or insert a medium object into various kinds of files;
selecting the desired note recorded contents of said web page by said reader; and
establishing (or opening) a note record file on said reader side and writing or inserting said selected note recorded contents of said web page into said note record file by said note record object if said reader wants to note record said contents of said web page.

2. The method, according to claim 1, wherein said reader can use the Single-Action to request for note recording, said Single-Action will activate said note record object to establish (or open) said note record file on said reader side and write or insert said selected contents of said web page into said note record file.

3. The method, according to claim 1, wherein said note recorded contents of said web page by said reader comprises a letter, a picture object, a voice object, a medium object or a hyperlink object.

4. The method, according to claim 1, further comprises the step of transmitting a file operation object to said reader side, wherein said file operation object can produce/delete any folder or any file on said reader side.

5. The method, according to claim 1, further comprises the step of transmitting an asynchronous operation object to said reader side, wherein said asynchronous operation object can asynchronously transmit various kinds of files between said reader side and said server side.

6. The method, according to claim 1, further comprises the step of transmitting a medium play object to said reader side, wherein said medium play object can play at least one said medium object on said web page on said reader side.

7. The method, according to claim 1, wherein said note recorded contents of said web page, can also be carried out on said server side, said reader can select said desired note recorded contents on said reader side and pass back said selected note recorded contents to said server side, said server will note record said selected note recorded contents passed back into a note record file inside said server by said note record object.

8. The method, according to claim 1, wherein said note recorded contents of said web page, can be carried out on said server side, said note recorded contents of said web page further comprising the data of appendix, and said reader can select an appendix on said reader side and pass back said selected appendix to said server side, and said server will then inquires the correlated information according to said appendix and note record said correlated information into a note record file inside said server by said note record object.

9. The method, according to claim 1, wherein said browser further comprises the program code of said note record object.

10. A server for note recording the contents of a web page on line, can provide said web page to a reader side via the connection of the communication link in order for said reader to note record said contents of said web page into various kinds of files easily. Said server comprises a CPU, a user interface, a communication interface and a memory, and said memory comprises an operating system, a communication access procedure and a web server procedure, and the feature of said server is in its said memory which further comprises a note record object which must be downloaded to said reader side if the action of note record can be carried out on said reader side, wherein said note record object can write a letter or insert a medium object into various kinds of files.

11. The server, according to claim 10, wherein said note recorded contents of said web page by said reader comprises a letter, a picture object, a voice object, a medium object or a hyperlink object.

12. The server, according to claim 10, wherein said memory further comprises a file operation object, and said file operation object must be downloaded to said reader side, wherein said file operation object can produce/delete any one folder or file.

13. The server, according to claim 10, wherein said memory further comprises an asynchronous operation object, and said asynchronous operation object must be downloaded to said reader side, wherein said asynchronous operation object can asynchronously transmit various kinds of files between said reader side and said server side.

14. The server, according to claim 10, wherein said memory further comprises a medium play object, and said medium play object must be downloaded to said reader side, wherein said medium play object can play any said medium object on said web page on said reader side.

15. A method for note recording the digital data, said method provides a software program to display a digital data in order for a reader to note record said digital data into various kinds of files easily, and the feature of said method is said software program further comprising a program code of a note record object, said note record object can write a letter or insert a medium object into various kinds of files, said method comprising the steps of:
selecting said digital data desired and note recorded by said reader, said digital data is displayed on a computer equipment for executing said software program; and
establishing (or opening) a note record file and writing or inserting said selected digital data into said note record file by said note record object if said reader wants to note record said digital data.

16. The method, according to claim 15, wherein said reader can use the Single-Action to request for note recording, and said Single-Action will activate said note record object to establish (or open) said note record file on said reader side and write or insert said selected digital data into said note record file.

17. The method, according to claim 15, wherein said software program can be stored in a computer readable storage medium.

18. The method, according to claim 15, wherein said note recorded digital data by said reader comprises a letter, a picture object, a voice object, a medium object or a hyperlink object.

19. The method, according to claim 15, wherein said software program comprises the software program of official document process, the software program of trial balance, the software program of database, the software program of e-mail or the software program of presentation.

20. The method, according to claim 15, wherein said software program comprises the software program of e-books.

21. The method, according to claim 15, wherein said digital data and said software program can be stored in a computer readable storage medium.

22. The method, according to claim 21, wherein said computer readable storage medium comprises the products of CAI.

23. The method, according to claim 15, wherein said memory of said computer equipment can store said digital data and said software program.

24. The method, according to claim 23, wherein said computer equipment comprises the electronic dictionary or the PDA.
